(19) United States
(12) Patent Application Publication
(10) Pub. No.: US 2018/0187404 A1
(43) Pub. Date: Jul. 5, 2018

(54) WALL-INSTALLABLE MACERATOR PUMP

(71) Applicant: Anthony Gaeto, Odessa, FL (US)

(72) Inventor: Anthony Gaeto, Odessa, FL (US)

(21) Appl. No.: 15/396,747

(22) Filed: Jan. 2, 2017

(51) Int. Cl. E03D 9/10; F04D 1/00; F04D 13/02; F04D 29/22; F04D 29/42; B02C 18/00

(52) U.S. Cl. CPC E03D 9/10; F04D 1/00; B02C 18/0092; F04D 29/2288; F04D 29/426; F04D 13/02

(57) ABSTRACT

A wall-installable macerator pump includes a tank, which is configured to house a macerating assembly. The width of the tank is configured to be positionable inside a cavity defined inside a wall. The macerating assembly comprises a motor, a pump cavity, and a chopper pump positioned inside the pump cavity. The motor receives sewage material through a sewage inlet, and sullage material through a sullage inlet, where the sewage inlet and the sullage inlet are positioned on the tank. The pump cavity receives the sewage material and sullage material, and a combination of the sewage material and sullage material defines a combined waste. The chopper pump positioned inside the pump cavity macerates and pumps the combined waste through a discharge outlet positioned on the tank.

### FIELD OF THE INVENTION

The present invention relates to a waste disposing macerator pump. More particularly, the present invention relates to an inside wall installable macerator pump configured to be positioned inside a wall to reduce space consumption and provide a more visually pleasing installation of the macerator pump.

### BACKGROUND

There are numerous methods for disposing of waste, for example, human waste disposed either at the site or at a remote location. Even though some on-site disposal type methods provide ways for on-site disposal of a mixture of flush water and human waste resulting from use of toilets, urinals, sinks and bathing areas or the like, it might be inconvenient to pump the waste off the on-site disposal locations because of the distance, elevation difference, or constraints on pipe size. For example, dumping waste in septic systems or community based sewage disposal systems may be difficult without a macerator pump.

There are requirements in which the waste must be reduced to a range of size before introduction into the current sewage disposal system, and such size may only be determined by the pipe sizes through which the material can pass through. This is where a macerator pump was introduced which could reduce materials, such as sullage or sewage waste, to a specific range of size so that the waste can be subsequently dumped of in-situ, avoiding restriction or such similar issues. However, conventional macerator pumps are designed to be positioned near the toilet, which can be positioned at a small distance away from the toilet bowl, or positioned adjacently behind the toilet bowl. Such arrangement might consume the space required for a user to easily move around the toilet and be unsightly, and if the toilet room space is small, the positioning of the macerator pump can cause significant reduction in space.

There are numerous prior art devices and methods which discuss different variants in macerator pump technology. For example, U.S. Pat. No. 8,769,730B2 which discusses a modular macerating unit that is easily moved to a convenient maintenance position, and if necessary, easily removed from the tank. The macerating apparatus may comprise a tank having an open top, a macerating unit disposed in the tank, and a main cover joined to the open top of the tank and comprising an opening. However, this patent does not address the need for an assembly that allows the macerator to be moved from behind the toilet to inside the wall. This allows bathrooms that use the macerator pumps to look more like typical bathrooms and would be quieter.

Considering U.S. Pat. No. 9,079,187B2, it proposes a macerator device arranged to allow for easy maintenance, possibly by a nonprofessional, in the case of the more commonplace breakdowns of this appliance. The macerator device provides a macerator device intended to be connected to a WC bowl, which consists of a tank into which the water and the matter from the WC bowl is brought. However, this patent does not address the need for a macerator assembly which allows the macerator to be moved from behind the toilet to inside the wall, and to create a typical bathroom which would be quieter. In contrast, considering a design based on the U.S. Pat. No. 9,079,187B2, a customer might have to limit the design to the suit the style and size of toilet that can be chosen for the bathroom.

Considering U.S. Pat. No. 8,276,218B2, it teaches a macerator toilet comprising a toilet body including a bowl portion and a base portion, the base portion defining a chamber and a macerator unit in fluid communication with the bowl portion, the macerator unit completely disposed in the chamber and operative for macerating a waste received from the bowl unit and pumping the waste from the macerator toilet. However, in this macerator toilet the customer's choice is limited to the style and size of toilet that can be chosen for the bathroom. Patent number WO2002066752A1 discusses a disintegrator for toilets, comprising a toilet with an outlet for draining the toilet disposals, where the toilet outlet is connected to means for disintegrating toilet disposals, where toilet has means for blocking the opening to an inlet pipe connected to the outlet of the toilet. However, in this patent that is essentially a different form of a macerator accommodation, since the installation is not within a wall.

Reference U.S. Pat. No. 9,416,524B2 teaches a piston-flush toilet system that may use appreciably less water than commonly used toilets today. Such a piston-flush toilet system may comprise a bowl to accept waste and a chamber comprising a waste inlet connected to the bowl and a waste outlet connected to a sewer system or the like. However, this patents is a different type of toilet that can either be used with or without a macerator pump. Reference patent number WO2016088105A1 teaches a macerator toilet assembly provided with a multi-material toilet having a base formed of a first material, a bowl formed of a second material, the multi material toilet being connectable to one of a waste tank directly below or to a remote waste tank indirectly. A macerator pump disposed on the toilet, downstream of a bowl outlet end; and, a trap assembly disposed downstream of the macerator pump. However, this patent is a multiple material made toilet that could either have a macerator installed within it cavity or be remotely connected. Further, this patent that is essentially another different form of a macerator installation, since the installation is not within a wall.

Hence, there is a long felt but unresolved need for a macerator pump that can be installed inside a wall so that it will prevent any space consumption.

### SUMMARY OF THE INVENTION

The wall installable macerator pump disclosed here, which is configured to be installed inside the wall addresses the above-mentioned issues, since the wall installable macerator pump can be installed inside any wall near the toilet, so that it will prevent any space consumption, in this case, if the macerator pump was positioned near the toilet bowl. The wall installable macerator pump comprises a tank, which is configured to temporarily receive the waste and water, and house a macerating assembly. The width of the tank is configured to be positionable inside a cavity defined as a wall, so that the positioning of the wall installable macerator pump retains available space inside the wall. The macerating assembly comprises a motor, a pump cavity, and a chopper pump positioned inside the pump cavity. The motor receives sewage material through a sewage inlet, and sullage material through a sullage inlets, where the sewage inlet and the sullage inlet are positioned on the tank. The pump cavity receives the sewage material and sullage material, and a combination of the sewage material and sullage material defines a combined waste. The chopper pump positioned inside the pump cavity macerates and pumps the combined waste through a discharge outlet positioned on the tank.

In an embodiment, the wall installable macerator pump further comprises an access door positioned on the wall proximal to the tank. The access door is configured for a user to perform maintenance activities on the wall installable macerator pump. In an embodiment, the wall installable macerator pump further comprises a vent outlet positioned on an upper surface of the tank. The vent outlet extends upwardly via a vent pipe, through the wall to terminate into the structures vent system or directly to the outside, and is configured to exhaust odor from the combined waste. In an embodiment, the discharge outlet extends from the tank, through the wall, and into an existing sewer or septic system.

### BRIEF DESCRIPTION OF THE DRAWINGS

FIG. 1A exemplarily illustrates a top perspective schematic view of the wall-installable macerator pump.

FIG. 1B exemplarily illustrates a front perspective schematic view of the wall-installable macerator pump.

FIG. 1C exemplarily illustrates a side perspective schematic view of the wall-installable macerator pump.

FIG. 2A exemplarily illustrates a top perspective schematic view of the wall-installable macerator pump positioned inside the wall.

FIG. 2B exemplarily illustrates a front perspective schematic view of the wall-installable macerator pump positioned inside a wall.

FIG. 2C exemplarily illustrates a side perspective schematic view of the wall-installable macerator pump positioned inside the wall.

FIG. 3 exemplarily illustrates a front perspective schematic view of the wall-installable macerator pump positioned inside a wall with the access door to perform maintenance on the motor.

### DETAILED DESCRIPTION OF THE INVENTION

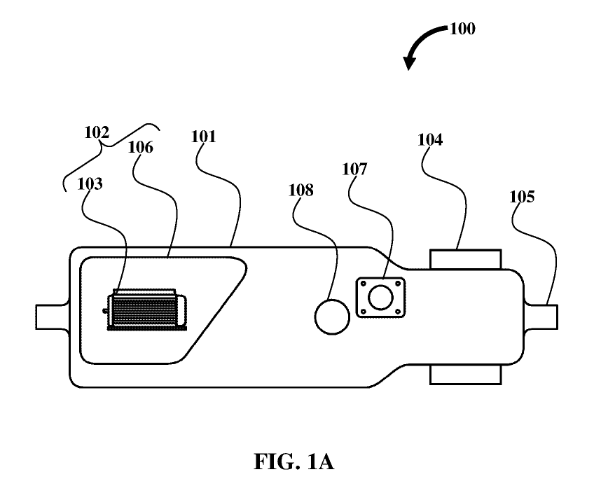

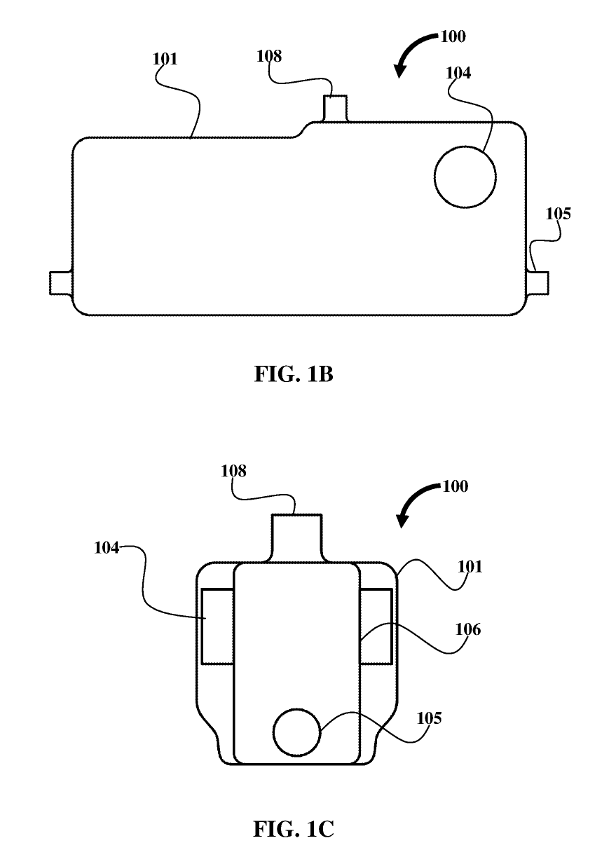

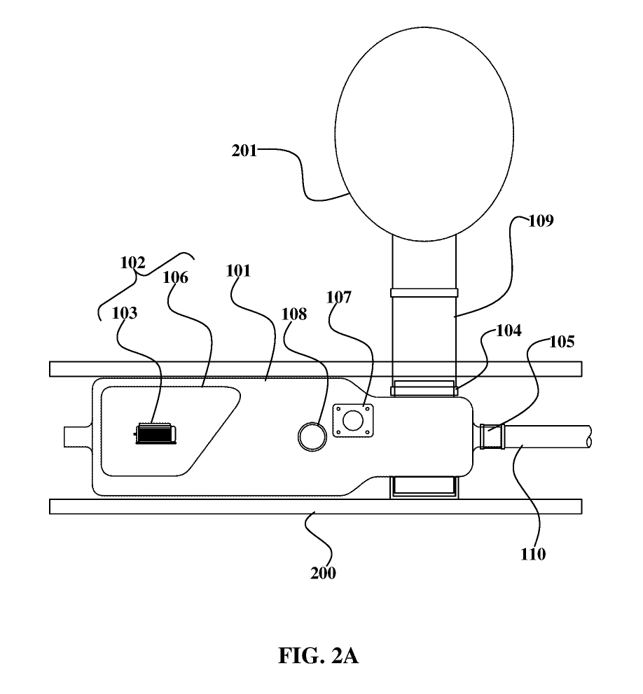

Referring to FIGS. 1A-1C, FIG. 1A exemplarily illustrates a top perspective schematic view of the wall-installable macerator pump 100, FIG. 1B exemplarily illustrates a front perspective schematic view of the wall-installable macerator pump 100, and FIG. 1C exemplarily illustrates a side perspective schematic view of the wall-installable macerator pump 100. The wall-installable macerator pump 100 generally has a tank 101, which is configured to house the corresponding pumping components. The pumping components housed within the tank 101 comprise the motor 103, the pump cavity 106, and the chopper pump (not shown). The wall-installable macerator pump 100 is designed to be positioned inside a wall 200, for example, drywall 200, which would be further described in the following sections. Other plumbing components comprise a sewage inlet 104, a sullage inlet 105, a discharge outlet 107, and a vent outlet 108 which convey inflow and outflow of waste matter. These components are designed so that they access the wall-installable macerator pump 100 through the drywall 200 in which the wall-installable macerator pump 100 is secured or positioned. This is achieved with the help of multiple openings in the drywall 200, which are aligned with the respective sewage inlet 104, sullage inlet 105, discharge outlet 107, and vent outlet 108.

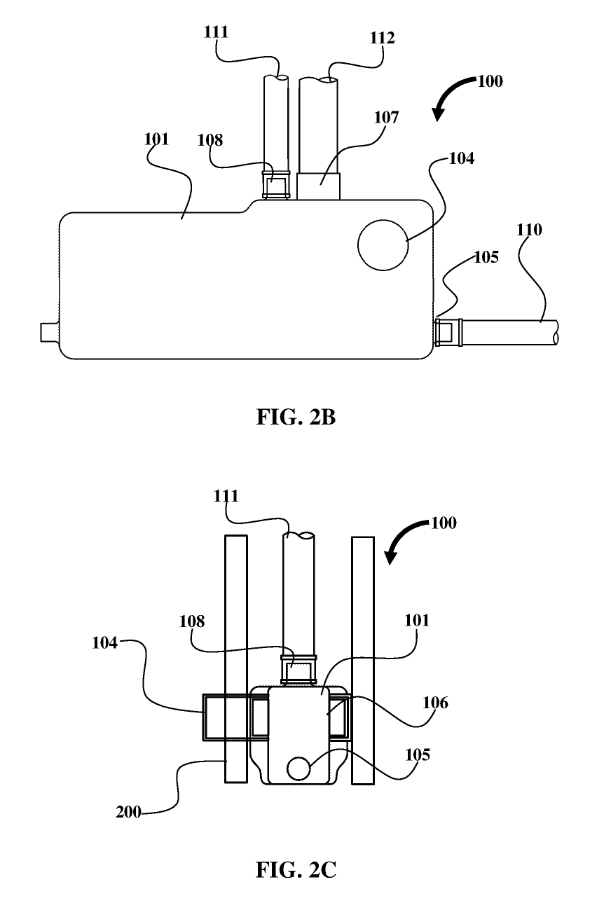

Referring to FIGS. 2A-2C, FIG. 2A exemplarily illustrates a top perspective schematic view of the wall-installable macerator pump 100 positioned inside the wall 200, FIG. 2B exemplarily illustrates a front perspective schematic view of the wall-installable macerator pump 100 positioned inside the wall 200, and FIG. 2C exemplarily illustrates a side perspective schematic view of the wall-installable macerator pump 100 positioned inside the wall 200. The wall-installable macerator pump 100 comprises a tank 101, which is configured to house a macerating assembly 102. The width of the tank 101 is configured to be positionable inside a cavity defined on a wall 200, so that the positioning of the wall-installable macerator pump 100 retains available space inside the wall. In conventional systems, the macerating units are generally positioned close to the toilet bowl 201 or attached behind the toilet bowl 201. Therefore, since the wall-installable macerator pump 100 is inserted and installed inside the wall 200 by creating a space inside the wall 200, the effective utility space or the available space for a user to move around the toilet is unaffected. Therefore, this arrangement makes it comfortable for the users who desire more space inside the toilet room.

The wall-installable macerator pump 100 comprises the motor 103, the pump cavity 106, and the chopper pump positioned inside the pump cavity 106, as mentioned in FIGS. 1A-1C. The motor 103 receives sewage material through the sewage inlet 104, and sullage material through a sullage inlet 105, where the sewage inlet 104 and the sullage inlet 105 are positioned on the tank 101. As disclosed herein, the term “sewage” refers to a suspension of water and solid waste, which are collected from the toilet bowl 201 to be disposed of, or processed. The term “sullage” refers to the liquid discharges from kitchens, washbasins, toilets, etc. The sewage inlet 104 and the sullage inlet 105 are connected to the wall-installable macerator pump 100 through pipe that passes through openings drilled through the wall 200. The sewage material is received at the sewage inlet 104 via a sewage pipe 109, and the sullage material is received at the sullage inlet 105 via a sullage pipe 110, which are coupled to the respective inlets.

The pump cavity 106 receives the sewage material and the sullage material, and a combination of the sewage material and sullage material defines a combined waste. The pump cavity 106 has a volume to collect the combined waste, which is then allowed to be reduced or grinded to smaller particles in the chopper pump. The grinding of the waste material is to make it pump-able either upwards from a basement location or horizontally to an existing septic or sewage system. The chopper pump positioned inside the pump cavity 106 macerates and pumps the combined waste through the discharge outlet 107 positioned on the tank 101. The chopper pump is generally a centrifugal pump, which includes sharp blades that slice and reduce the solid particles in the sewage material to a smaller size.

Further, the chopper pump pumps the reduced combined waste through the discharge outlet 107, and the reduced combined waste is collected in a community waste treatment system or a waste collection tank. Therefore, the wall-installable macerator pump 100 is not an essential part of any conventional treatment system, but a suitable method to transfer the waste material to the treatment system. The discharge outlet 107 extends from the tank 101, through the wall 200, and into an existing sewer or septic system. The discharge outlet 107 is connected to a discharge pipe 112 to transfer the combined waste to the septic system. In an embodiment, the wall-installable macerator pump 100 further comprises vent outlet 108 positioned on an upper surface of the tank 101. The vent outlet 108 extends upwardly via a vent pipe 111 through the wall 200 to terminate into the structures pluming a vent system or directly to the outside, and is configured to exhaust odor from the combined waste as shown in FIG. 2B-2C.

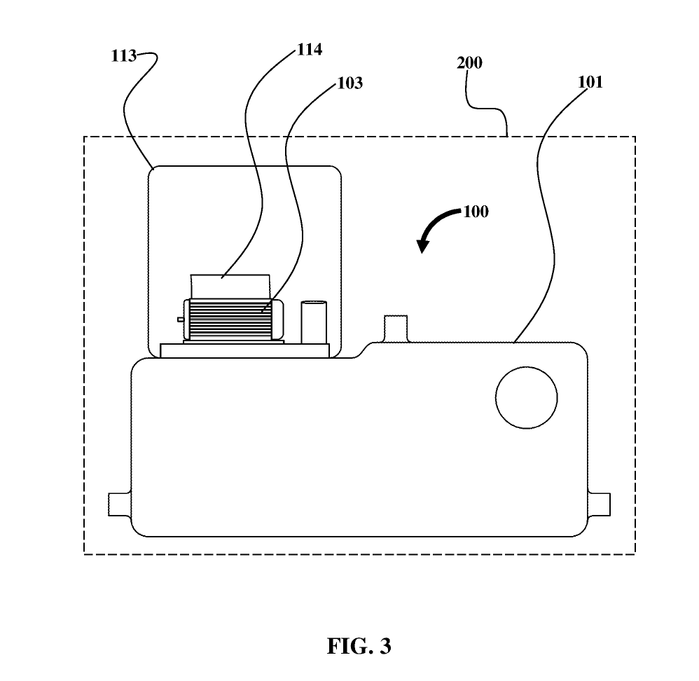

FIG. 3 exemplarily illustrates a front perspective view of the wall-installable macerator pump 100 positioned inside a wall 200 with the access door 113 to perform maintenance on the motor 103. In an embodiment, the wall-installable macerator pump 100 further comprises an access door 113 positioned on the wall 200 proximal to the tank 101. The access door 113 is configured to perform maintenance activities on the wall-installable macerator pump 100. The access door 113 can be constructed on either side of the wall 200 depending on the user's choice. The access door 113 on the wall 200 provides easy access for maintenance workers so that the maintenance workers can open the access door 113 and remove the cap 114 of the motor 103, so that they can fix any problem related to the motor 103.

The wall-installable macerator pump 100 can be installed behind the wall of the toilet in either direction. The wall-installable macerator pump 100 would be positioned inside the drywall 200 proximal to the toilet; therefore, the bottom of the tank is contoured so that the drywall 200 screws will not penetrate the tank when the drywall 200 is installed. Unused toilet and other inlets can be capped without interfering with the drywall 200. The supplementary inlets and outlets are centered so that they can be plumbed from sufficient distance from the wall 200.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A wall-installable macerator pump configured to be installed inside a wall of a toilet room, the wall-installable macerator pump comprising;
a tank configured to house a macerating assembly, wherein the width of the tank is configured to be positionable inside a cavity defined inside the wall to retain available space near the toilet; and
the macerating assembly comprising:
a motor configured to receive sewage material through a sewage inlet, and sullage material through a sullage inlet, wherein the sewage inlet and the sullage inlet are positioned on the tank;
a pump cavity configured to receive the sewage material and sullage material, wherein a combination of the sewage material and sullage material defines a combined waste; and
a chopper pump positioned inside the pump cavity, wherein the chopper pump is configured to macerate and pump the combined waste through a discharge outlet positioned on the tank.

2. The wall-installable macerator pump of claim 1, further comprising an access door positioned in the drywall proximal to the tank, wherein the access door is configured for a user to perform maintenance activities on the wall-installable macerator pump.

3. The wall-installable macerator pump of claim 1, further comprising a vent outlet positioned on an upper surface of the tank, wherein the vent outlet extends upwardly via a vent pipe through the wall to terminate at an upper end of the wall, wherein the vent pipe is configured to exhaust odor from the combined waste.

4. The wall-installable macerator pump of claim 1, wherein the discharge outlet extends from the tank, through the wall, and into an existing sewer system.
